(19) United States
(12) Patent Application Publication
(10) Pub. No.: US 2014/0238553 A1
(43) Pub. Date: Aug. 28, 2014

(54) SINTERED BODY THAT IS PRECURSOR OF RARE-EARTH MAGNET, AND METHOD FOR PRODUCING MAGNETIC POWDER FOR FORMING THE SAME

(71) Applicants: Noritsugu Sakuma, Susono-shi (JP); Hidefumi Kishimoto, Susono-shi (JP); Masao Yano, Susono-shi (JP)

(72) Inventors: Noritsugu Sakuma, Susono-shi (JP); Hidefumi Kishimoto, Susono-shi (JP); Masao Yano, Susono-shi (JP)

(73) Assignee: TOYOTA JIDOSHA KABUSHIKI KAISHA, Toyota-shi, Aichi (JP)

(21) Appl. No.: 14/350,418

(22) PCT Filed: Oct. 9, 2012
(86) PCT No.: PCT/JP2012/076066

§ 371 Date: Apr. 8, 2014

(30) Foreign Application Priority Data
Oct. 11, 2011 (JP) 2011-224071

(51) Int. Cl. H01F 1/053; B22F 9/06; H01F 41/00

(52) U.S. Cl. CPC H01F 1/0536; H01F 41/00; B22F 9/06
USPC 148/513; 75/246

(57) ABSTRACT

Provided are a sintered body for forming a rare-earth magnet with a high degree of orientation and high remanent magnetization, and a method for producing magnetic powder for forming the sintered body. A sintered body S that is a precursor of a rare-earth magnet, the sintered body S including crystal grains g2 of an Nd—Fe—B-based main phase with a nanocrystalline structure, and a grain boundary phase around the main phase, and the rare-earth magnet being adapted to be formed by applying hot deformation processing to the sintered body S for imparting anisotropy thereto and further diffusing an alloy for improving coercivity therein. Each crystal grain g2 that forms the sintered body S has a planar shape that is, when viewed from a direction perpendicular to an easy direction of magnetization (i.e., a c-axis direction), a rectangle having sides in the c-axis direction and sides in a direction (i.e., an a-axis direction) that is perpendicular to the c-axis direction, or a shape that is close to the rectangle.

### TECHNICAL FIELD

The present invention relates to a sintered body that is a precursor of a rare-earth magnet, and a method for producing magnetic powder for forming the sintered body.

### BACKGROUND ART

Rare-earth magnets that use rare-earth elements, such as lanthanoid, are also called permanent magnets. Such magnets are used not only for hard disks or motors of MRI but also for driving motors of hybrid vehicles, electric vehicles, and the like.

As examples of magnetic performance indices of such rare-earth magnet, remanent magnetization (i.e., residual magnetic flux density) and coercivity can be given. However, with a reduction in the motor size and an increase in the amount of heat generation accompanied by an increase in the current density, there has been an increasing demand for higher heat resistance of the rare-earth magnet being used. Thus, how to retain the coercivity of a magnet under high-temperature use environments is an important research object to be achieved in the technical field. For example, for a Nd—Fe—B-based magnet, which is one of the rare-earth magnets that are frequently used for vehicle driving motors, attempts have been made to increase the coercivity by, for example, reducing the crystal grain size, using an alloy with a high Nd content, or adding a heavy rare-earth element with high coercivity performance, such as Dy or Tb.

Examples of rare-earth magnets include typical sintered magnets whose crystal grains (i.e., a main phase) that form the structure have a scale of about 3 to 5 μm, and nanocrystalline magnets whose crystal grain size has been reduced down to a nano-scale of about 50 to 300 nm. Among them, nanocrystalline magnets for which the amount of addition of an expensive heavy rare-earth element can be reduced (i.e., reduced to zero) while the crystal grain size can also be reduced as described above are currently attracting attention.

The resource cost of Dy, which is frequently used among heavy rare-earth elements, has been rapidly increasing since the Japanese fiscal year 2011 as the prospecting areas of Dy are mostly distributed in China and the amount of production as well as the amount of exports of rare metals, such as Dy, by China is now regulated. Therefore, development of a magnet with a less Dy content, which has a reduced Dy content but has ensured coercive performance, and a Dy-free magnet, which contains no Dy but has ensured coercive performance, is one of the important development tasks to be achieved, and this has been one of the factors that are increasing the degree of attention of nanocrystalline magnets.

A method for producing a nanocrystalline magnet is briefly described below. For example, a melt of a Nd—Fe—B-based metal is discharged onto a chill roll to rapidly solidify the melt, and the resulting quenched ribbon (i.e., quenched thin strip) is ground into magnetic powder, and then the magnetic powder is sintered while pressure is applied thereto at the same time, whereby a sintered body is produced. In order to impart magnetic anisotropy to such a sintered body, hot deformation processing (which can also be called hot high-strength processing or be simply called high-strength processing if the degree of processing (i.e., compressibility) of the hot deformation processing is high, for example, when the compressibility is greater than or equal to about 10%, and the sintered body can also be called a precursor of the high-strength processing) is applied to produce a molded body. As described above, in order to produce a rare-earth magnet, a sintered body is produced first as a precursor, and then, a molded body is produced. Such a method for producing a molded body by applying hot deformation processing to the sintered body is disclosed in Patent Literature 1.

A heavy rare-earth element with high coercivity performance, an alloy thereof, or the like is imparted to the molded body obtained through the hot deformation processing, whereby a rare-earth magnet made of a nanocrystalline magnet is produced.

It has been found that when a sintered body contains crystal grains without coarse grains, if the sintered body is subjected to hot deformation processing, the crystal grains (typically, a Nd₂Fe₁₄B phase) will turn (or rotate) along with slip deformation that occurs due to the hot deformation processing, and the easy axis of magnetization (i.e., c-axis) will be oriented in the processing direction (i.e., the press direction), whereby a molded body with a high degree of orientation can be obtained, and also the remanent magnetization can be increased. In this specification, among the nanocrystalline grains, a crystal grain with the maximum diameter of 300 nm or greater will be defined as a “coarse grain.” It has also been found that when such coarse grain is present, or when the percentage of such coarse grains is high, rotation of the crystal grains will be suppressed, and thus, the aforementioned degree of orientation will be likely to decrease.

However, for obtaining such a rare-earth magnet with a high degree of orientation, there have been no techniques that are focused on the shapes of the crystal grains of a sintered body that is a precursor of the magnet. The inventors have conducted concentrated studies and found that defining the shapes of the crystal grains of a sintered body that is a precursor of a rare-earth magnet can identify a rare-earth magnet with a high degree of orientation and high remanent magnetization.

In the production of magnetic powder for forming a sintered body, a quenched ribbon is produced by rapidly solidifying a metal melt as described above. However, it has been known that depending on the quenching speed in the production of the quenched ribbon, a quenched ribbon with a variety of structures may be formed, such as an amorphous quenched ribbon, a quenched ribbon containing both amorphous and crystal (crystalline) grains, or a quenched ribbon containing only crystal grains.

The inventors have also found that the quenching speed in the formation of a quenched ribbon determines the structure of magnetic powder for forming a sintered body. That is, depending on the structure of the magnetic powder, the shapes of the crystal grains of the sintered body will change, which in turn will influence the degree of orientation of a molded body to be formed.

Thus, the present specification defines a rare-earth magnet with a high degree of orientation by the shapes of the crystal grains of a sintered body that is a precursor of the magnet, and also provides a method for producing magnetic powder for forming such a sintered body.

### CITATION LIST

### Patent Literature

Patent Literature 1: JP 2011-100881 A

### SUMMARY OF INVENTION

### Technical Problem

The present invention has been made in view of the foregoing problems. It is an object of the present invention to provide a sintered body for forming a rare-earth magnet with a high degree of orientation and high remanent magnetization, and a method for producing magnetic powder for forming such a sintered body.

### Solution to Problem

In order to achieve the above object, a sintered body that is a precursor of a rare-earth magnet in accordance with the present invention is a sintered body including crystal grains of an Nd—Fe—B-based main phase with a nanocrystalline structure, and a grain boundary phase around the main phase, and the rare-earth magnet being adapted to be formed by applying hot deformation processing to the sintered body for imparting anisotropy thereto and further diffusing an alloy for improving coercivity therein. Each crystal grain that forms the sintered body has a planar shape that is, when viewed from a direction perpendicular to the easy direction of magnetization (i.e., the c-axis direction), a rectangle having sides in the c-axis direction and sides in a direction (i.e., the a-axis direction) that is perpendicular to the c-axis direction, or a shape that is close to the rectangle.

When the planar shape of each crystal grain is a rectangle or the like, the stereoscopic shape thereof is a polyhedron (i.e., a hexahedron (i.e., a cuboid), an octahedron, or a solid that is close thereto) whose surface of the crystal grain is surrounded by low-index (Miller index) planes. For example, when the stereoscopic shape is a hexahedron, the axis of orientation is formed on the (001) plane (i.e., the easy direction of magnetization (i.e., the c-axis direction) coincides with the top and bottom faces of the hexahedron), and the side faces are formed of (110), (100) or a Miller index that is close thereto.

Herein, the “shape that is close to the rectangle” includes a quadrangle without four angles that are orthogonal to one another unlike a rectangle, a polyhedron other than the quadrangle, a flat ellipse, and the like. Thus, crystal grains that form the structure of the sintered body may have a configuration in which the planar shapes of all the crystal grains are rectangles, a configuration in which some of the planar shapes of the crystal grains are rectangles and the others are shapes that are close to rectangles (e.g., ellipses), and a configuration in which the planar shapes of all the crystal grains are shapes that are close to rectangles.

The inventors have identified that in a sintered body that is a precursor of a rare-earth magnet, which has crystal grains whose short sides are in the c-axis direction and whose long sides are in the direction that is perpendicular to the c-axis, the crystal grains will easily turn during the subsequent hot deformation processing due to the their shapes, and the degree of orientation becomes about 90% or more (about 93 or 94%), regardless of whether the planar shapes of the crystal grains are rectangles or shapes that are close to rectangles. It should be noted that the degree of orientation of crystal grains that form the molded body or the rare-earth magnet can be measured using a VSM (Vibrating Sample Magnetometer).

As a preferred embodiment of the sintered body that is a precursor of a rare-earth magnet in accordance with the present invention, provided that the length of the sides in the c-axis direction is t1 and the length of the sides in the a-axis direction is t2, the planar shape is in the range of 1.4≦t2/t1≦10.

Provided that the length of the short sides in the c-axis direction is t1, and the length of the long sides in the a-axis direction is t2, if the aspect ratio t2/t1 is set in the range of 1.4≦t2/t1≦10, it is possible to define a sintered body with crystal grains with a higher degree of orientation.

The inventors have, as a result of verifying the degree of orientation (or the remanent magnetization (Mr)/saturation magnetization (Ms)) for when the aspect ratio t2/t1 is variously changed, verified that the degree of orientation tends to increase with an increase in the aspect ratio t2/t1, and the rise curve has an inflection point at an aspect ratio t2/t1 of 1.4, and is saturated at the maximum value, which is more than 90%, at an aspect ratio t2/t1 of about 3. Thus, 1.4 that provides the inflection point is defined as the lower limit value of the aspect ratio t2/t1 .

Meanwhile, the inventors have also identified that the grain size range of the crystal grains of the sintered body (e.g., the maximum value and the minimum value of the grain sizes of all the crystal grains that are included in an area of 100 μm×100 μm square of the sintered body, which have been identified through observation with TEM) is preferably in the range of 20 to 200 nm to provide a high degree of orientation.

When the length t2 of the sides in the a-axis direction is 200 nm that is the maximum value and the length t1 of the sides in the c-axis direction is 20 nm that is the minimum value, the aspect ratio t2/t1 becomes 10. Thus, 10 that is defined by such desirable crystal grain size range is defined as the upper limit value of the aspect ratio t2/t1.

The present invention also relates to a method for producing magnetic powder for forming a sintered body that is a precursor of a rare-earth magnet. Such a production method is a method for producing magnetic powder for forming the sintered body that includes discharging a Nd—Fe—B-based metal melt onto a surface of a chill roll; solidifying the metal melt through liquid quenching at a quenching speed in the range of 10⁵ to 10⁶ K/s to produce a quenched ribbon; and grinding the quenched ribbon into the magnetic powder.

The inventors have identified that when the quenching speed is in the range of 10⁵ to 106 K/s, the structure of the quenched ribbon has crystal grains each having a planar shape that is, when viewed from a direction perpendicular to the c-axis direction, a rectangle having sides in the c-axis direction and sides in the a-axis direction that is perpendicular to the c-axis, or a shape that is close to the rectangle.

The “quenching speed” herein is calculated by specifying a region of a metal melt immediately before it comes into contact with a chill roll that rotates at a rotating speed v (m/s) and defining the maximum temperature in the region as T1, and specifying a region of L(m) after solidification on the chill roll and defining the maximum temperature in the region as T2, and then calculating the temperature difference ΔT between T2 and T1, and taking into consideration the rotating speed of the chill roll.

The grinding method used to produce magnetic powder by grinding a quenched ribbon may use a device that can perform grinding with low energy, such as a mortar, a cutter mill, a pot mill, a jaw crusher, or a jet mill since it is concerned that if a method using a high-rotation-speed grinder, such as a ball mill or a bead mill, is used, significant distortion would be introduced into the quenched powder, which in turn can decrease the magnetic properties.

Another embodiment of the production method is a method that includes discharging a Nd—Fe—B-based metal melt onto a surface of a chill roll; solidifying the metal melt through liquid quenching at a quenching speed outside the range of 10⁵ to 10⁶ K/s, and applying heat treatment at 500 to 800° C. to produce a quenched ribbon; and grinding the quenched ribbon into the magnetic powder.

The inventors have identified that when the quenching speed is outside the range of 10⁵ to 10⁶ K/s, that is, when the range of the quenching speed is slower than 10⁵ K/s or is higher than 10⁶ K/s, the resulting quenched ribbon exhibits a structure that includes only amorphous grains, a structure that partially includes amorphous grains, or a structure including equi-axed grains (i.e., a shape whose aspect ratio t2/t1 is lower than 1.4 and has a shape that is close to a distorted sphere).

When a quenched ribbon with a structure that partially or entirely includes amorphous grains is further subjected to heat treatment at 500 to 800° C., it is possible to cause grain growth by which the aspect ratio t2/t1 is increased, that is, anisotropic growth by which the growth in the a-axis direction is prominent, whereby it is possible to obtain a quenched ribbon with a structure including crystal grains each having a planar shape that is, when viewed from a direction perpendicular to the c-axis direction, a rectangle having sides in the c-axis direction and sides in the a-axis direction that is perpendicular to the c-axis direction, or a shape that is close to the rectangle.

The sintered body of the present invention is produced using the aforementioned magnetic powder, and when hot deformation processing (high-strength processing) is applied to the sintered body, an anisotropic molded body is produced.

A heavy rare-earth element (e.g., Dy, Tb, or Ho) with high coercivity performance, an alloy thereof (e.g., Dy—Cu or Dy—Al), or the like is diffused in the grain boundaries of the produced molded body using various methods, whereby a rare-earth magnet made of a nanocrystalline magnet that is excellent in both magnetization and coercivity is obtained.

### Advantageous Effects of Invention

As can be understood from the foregoing description, according to a sintered body that is a precursor of a rare-earth magnet of the present invention and a method for producing magnetic powder for forming the sintered body, when each of the crystal grains that form the sintered body has a planar shape that is, when viewed from a direction perpendicular to the easy direction of magnetization (i.e., the c-axis direction), a rectangle having sides in the c-axis direction and sides in the a-axis direction that is perpendicular to the c-axis direction, or a shape that is close to the rectangle, it is possible to allow the crystal grains to turn or easily turn during the subsequent hot deformation processing, which in turn will increase the degree of orientation, whereby a sintered body for forming a rare-earth magnet with a high degree of orientation and high remanent magnetization can be obtained.

### BRIEF DESCRIPTION OF DRAWINGS

FIG. 1(a) is a diagram illustrating a method for producing a quenched ribbon, FIG. 1(b) is a diagram illustrating a method for producing a sintered body, and FIG. 1(c) is a diagram illustrating a method for producing a molded body.

FIG. 2 are views each illustrating the structure of a quenched ribbon in accordance with the quenching speed, specifically, FIG. 2a is a structure view for when a quenched ribbon is produced at a quenching speed of about 10⁷ K/s, FIG. 2b is a structure view for when a quenched ribbon is produced at a quenching speed of 10⁶ to 10⁷ K/s, FIG. 2c is a structure view for when a quenched ribbon is produced at a quenching speed of 10⁵ to 10⁶ K/s, and FIG. 2d is a structure view for when a quenched ribbon is produced at a quenching speed that is slower than 10⁵ K/s.

FIG. 3 is a schematic diagram illustrating a method of defining the quenching speed.

FIGS. 4(a), (b), and (c) are views each showing an embodiment of the crystal grains that form a sintered body.

FIG. 5 is a structure view of a molded body that is formed by applying hot deformation processing to the sintered body shown in FIG. 4.

FIG. 6(a) is a SEM image view of a sintered body that is a precursor of a molded body of Example 2, FIG. 6(b) is a TEM image view of a sintered body that is a precursor of a molded body of Example 3, FIG. 6(c) is a SEM image view of a sintered body that is a precursor of a molded body of a comparative example, and FIG. 6(d) is an enlarged TEM image view of FIG. 6(c).

FIG. 7 is a chart showing the experimental results related to the relationship between the aspect ratio t2/t1 of the crystal grains that form each sintered body and the degree of orientation of a molded body formed from the sintered body.

### DESCRIPTION OF EMBODIMENTS

Hereinafter, an embodiment of a sintered body that is a precursor of a rare-earth magnet of the present invention, and a method for producing magnetic powder for forming the sintered body will be described with reference to the drawings.

### (Method for Producing Magnetic Powder)

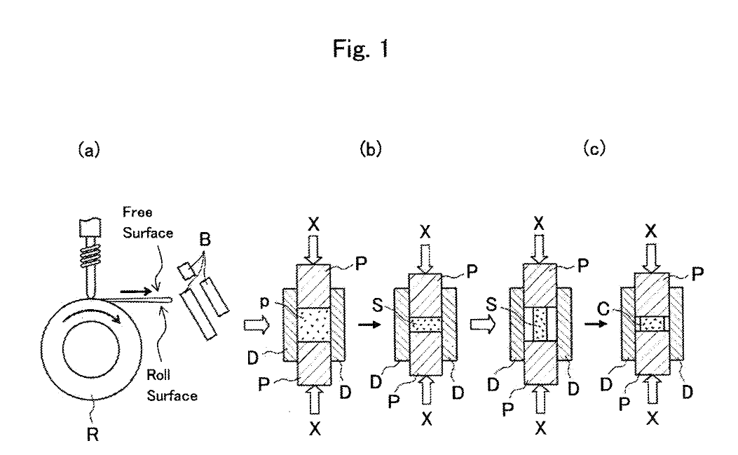

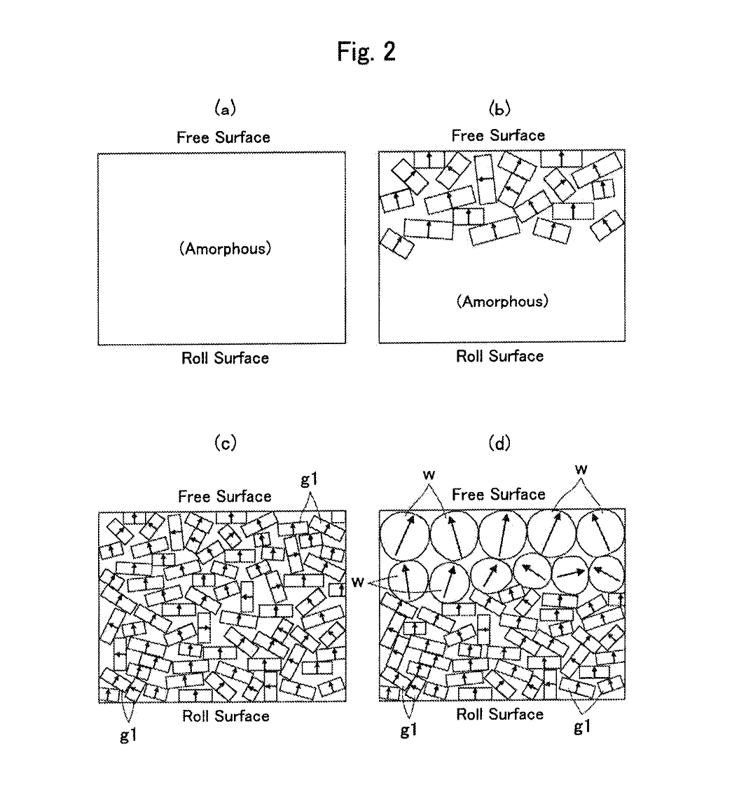

FIGS. 1a, 1b, and 1c are flow diagrams that sequentially show the production of a quenched ribbon, the production of a sintered body that uses magnetic powder obtained by grinding the quenched ribbon, and the production of a molded body through application of hot deformation processing to the sintered body. FIG. 1a is a diagram illustrating a method for producing a quenched ribbon. FIG. 2 are views each illustrating the structure of a quenched ribbon in accordance with the quenching speed, specifically, FIG. 2a is a structure view for when a quenched ribbon is produced at a quenching speed of about 10⁷ K/s, FIG. 2b is a structure view for when a quenched ribbon is produced at a quenching speed of 106 to 10⁷ K/s, FIG. 2c is a structure view for when a quenched ribbon is produced at a quenching speed of 10⁵ to 10⁶ K/s, and FIG. 2d is a structure view for when a quenched ribbon is produced at a quenching speed that is slower than 10⁵ K/s.

As shown in FIG. 1a, an alloy ingot is melted at high frequency through single-roll melt-spinning in a furnace (not shown) with an Ar gas atmosphere whose pressure has been reduced to 50 kPa or less, for example, and then the molten metal with a composition that will provide a rare-earth magnet is sprayed at a chill roll R made of copper to produce a quenched ribbon B (i.e., a quenched thin strip). Then, the quenched ribbon B is coarsely ground. It should be noted that a region of the quenched ribbon B on the side of the chill roll R (e.g., a region of half the thickness of the quenched ribbon B on the side of the chill roll R) can be called a roll surface, and a region on the opposite side thereof can be called a free surface. The two regions differ in the growth speed of the crystal grains as the distances from the chill roll R differ.

The composition of the molten alloy (i.e., the composition of a NdFeB magnet) is represented by the compositional formula: (Rl)x(Rh)yTzBsMt, where Rl represents one or more light rare-earth elements including Y, Rh represents one or more heavy rare-earth elements including Dy or Tb, T represents a transition metal including at least one of Fe, Ni, or Co, M represents one or more metals selected from Ga, Zn, Si, Al, Nb, Zr, Ni, Cu, Cr, Hf, Mo, P, C, Mg, Hg, Ag, or Au, and 13≦x≦20, 0≦y≦4, z=100−a−b−d−e−f, 4≦s≦20, 0≦t≦3. It is possible to apply the compositions of RlRh phase structures, such as a main phase of (RlRh)2T14B) and a grain boundary phase of (RlRh)T4B4, or the compositions of RlRh phase structures, such as a main phase of (RlRh)2T14B) and a grain boundary phase of (RlRh)2T17.

As a method of coarsely grinding the quenched ribbon B, grinding is performed with a device that can perform grinding with low energy, such as a mortar, a cutter mill, a pot mill, a jaw crusher, or a jet mill. The grain size of magnetic powder obtained through coarse grinding is preferably adjusted to the range of about 50 to 1000 μm, and a magnetic adsorption separation method can be applied to eliminate magnetic powder with coarse grains.

To this end, magnetic powder is adsorbed onto a magnet with low magnetic properties. Magnetic powder adsorbed onto a magnet with low magnetic properties has low coercivity as it contains coarse grains, while magnetic powder not adsorbed onto the magnet with low magnetic properties has high coercivity as it does not contain coarse grains. For example, magnetic powder that has not been magnetically adsorbed can be collected and used for the production of a sintered body. At this time, if the grain size is over 1000 μm, it would be difficult to apply the magnetic separation method, while if the grain size is less than 50 μm, the magnetic properties would significantly decrease due to distortion introduced during grinding. Thus, the grain size range of the magnetic powder is preferably 50 to 1000 μm.

Herein, the fact that the structure of the produced quenched ribbon B greatly differs depending on the quenching speed will be described with reference to FIG. 2.

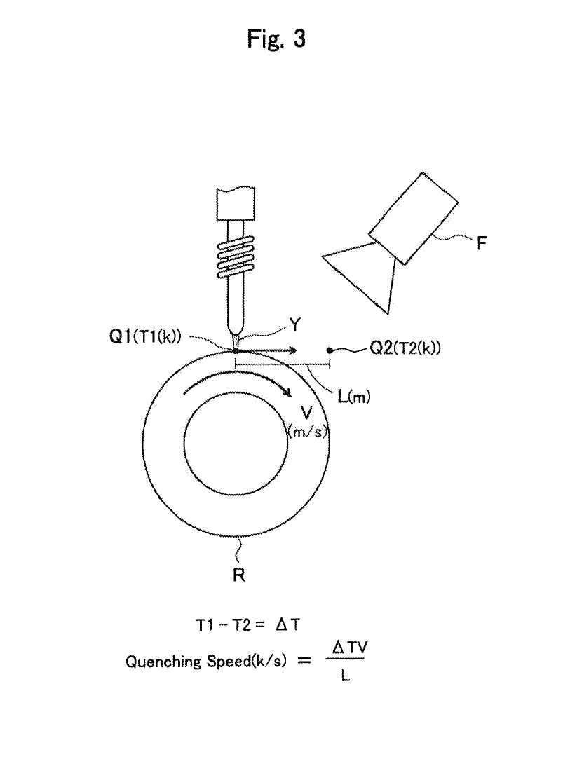

First, the “quenching speed” will be described with reference to FIG. 3. As shown, a system including a high-frequency nozzle, a chill roll R, an infrared camera F (e.g., TS9230H-A01 of Nippon Avionics Co., Ltd.) is constructed. Then, the temperature T1 (K) before solidification at a point Q1 where a melt Y discharged from the high-frequency nozzle is in contact with the chill roll R, which is rotating at a rotating speed V (m/s), and the temperature T2 (K) at a point Q2 where the melt has been solidified on the chill roll R and that is away from the point Q1 by L(m) are measured by the infrared camera F. Then, the temperature difference ΔT between T2 and T1 is determined, and the quenching speed ΔTV/L (K/s) is calculated by taking the rotating speed V (m/s) of the chill roll into consideration.

Referring again to FIG. 2, the structure view shown in FIG. 2a is that for when a quenched ribbon is produced at a quenching speed of about 10⁷ K/s. As shown, when the quenching speed is about 10⁷ K/s or higher, the crystal grains do not grow, resulting in a quenched ribbon with an amorphous structure.

Meanwhile, the structure view shown in FIG. 2b is that for when a quenched ribbon is produced at a quenching speed in the range of 10⁶ to 10⁷ K/s. As shown, when a quenched ribbon is quenched in such a speed range, the roll-surface-side region remains amorphous, but fine crystal grains g1 are generated in the free-surface-side region, resulting in a quenched ribbon with a structure that includes both the crystal grains g1 and an amorphous structure.

The structure view shown in FIG. 2c is that for when a quenched ribbon is produced at a quenching speed in the range of 10⁵ to 10⁶ K/s. As shown, when a quenched ribbon is quenched in such a speed range, the entire structure becomes a quenched ribbon with crystal grains g1 without coarse grains. The inventors have identified that crystal grains that form a sintered body, which is obtained by producing magnetic powder from a quenched ribbon formed under such quenching speed condition and sintering the magnetic powder, is likely to have a grain size range (the range of the maximum grain size and the minimum grain size) of 20 to 200 nm. The crystal grains in such a grain size range that form the sintered body that is a precursor of high-strength processing will easily turn (or rotate) during the hot deformation processing, and thus, a molded body with a high degree of orientation can be easily obtained.

Further, the structure view shown in FIG. 2d is that for when a quenched ribbon is produced at a quenching speed that is slower than 10⁵ K/s. As shown, when a quenched ribbon is quenched in such a speed range, grain growth of the crystal grains on the free-surface side is promoted, whereby coarse grains w with a maximum grain size of 300 nm are formed.

When the quenching speed is adjusted to a speed in the range of 10⁵ to 10⁶ K/s and a quenched ribbon with the crystalline structure shown in FIG. 2c is obtained, the quenched ribbon is ground into magnetic powder in the grain size range of 50 to 1000 μm for forming a sintered body.

Meanwhile, when a quenched ribbon that partially contains an amorphous structure in the structure thereof is obtained as shown in FIGS. 2a and 2b, applying heat treatment to the quenched ribbon at 500 to 800° C. can cause grain growth of the amorphous structure while suppressing coarsening of the crystal grains. Consequently, a quenched ribbon with crystal grains, the entire structure of which does not contain coarse grains as shown in FIG. 2c, is obtained.

As described above, a quenched ribbon is produced by solidifying a metal melt through liquid quenching at a quenching speed in the range of 10⁵ to 10⁶ K/s, and then the quenched ribbon is ground; or a quenched ribbon is produced by solidifying a metal melt through liquid quenching at a quenching speed outside the range of 10⁵ to 10⁶ K/s and applying heat treatment thereto at 500 to 800° C., and then the quenched ribbon is ground. Accordingly, magnetic powder for forming a sintered body that is a precursor of a rare-earth magnet is produced.

### (Sintered Body and Production Method Therefor)

FIG. 1b is a diagram illustrating a method for producing a sintered body. A cavity, which is defined by a carbide die D and a carbide punch P that slides within a hollow space therein, is filled with the produced magnetic powder p as shown in FIG. 1b, and then, pressure is applied thereto with the carbide punch P, and electrical heating is performed with current made to flow in the pressure application direction (i.e., the X-direction), whereby a sintered body S is produced that contains a Nd—Fe—B-based main phase with a nanocrystalline structure (crystal grains in the grain size range of 20 to 200 nm) and a grain boundary phase around the main phase, such as an Nd—X alloy (where X is a metallic element).

The sintered body is preferably produced under an inert gas atmosphere by setting the heating temperature of electrical heating to the range of 550 to 700° C., which is a low temperature range in which coarsening of the crystal grains does not occur, setting the pressure to 40 to 500 MPa, which is a pressure range in which coarsening can be suppressed, and setting the retention time to less than or equal to 60 minutes.

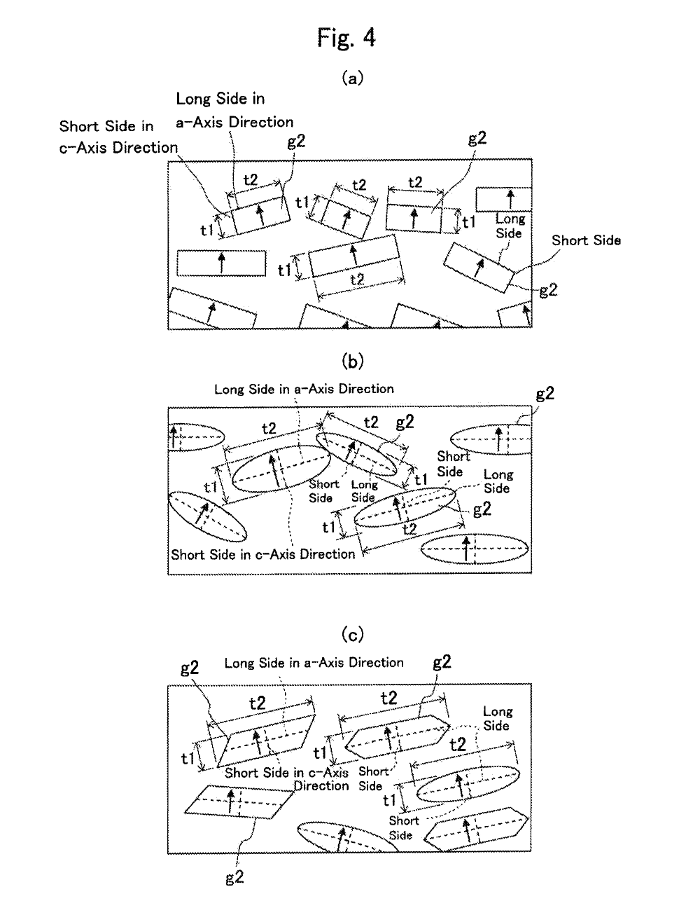

Next, the planar shapes of the crystal grains of the formed sintered body that is a precursor of a rare-earth magnet will be described with reference to FIGS. 4a, 4b, and 4c.

Each crystal grain shown herein shows the planar shape of a crystal grain g2 seen from a direction (i.e., a direction perpendicular to the paper surface) perpendicular to the easy direction of magnetization (i.e., the c-axis direction). The planar shape is a rectangle having short sides in the c-axis direction and long sides in the direction that is perpendicular to the c-axis direction (i.e., the a-axis direction), or a shape that is close to the rectangle. It should be noted that the rectangle includes a square.

The planar shape of the crystal grain g2 shown in FIG. 4a is a rectangle, and rectangular crystal grains g2 with various dimensions that have short sides in the easy direction of magnetization (i.e., the c-axis direction) and long sides in the a-axis direction that is perpendicular to the c-axis direction form the structure.

Herein, each of t1 and t2 is in the range of 20 to 200 nm, and the aspect ratio t2/t1 is in the range of 1.4≦t2/t1≦10.

As a method for measuring (checking) the maximum grain size and the minimum grain size, it is possible to use a method for measuring the maximum grain size and the minimum grain size of all the crystal grains g2 that are included in a given range (e.g., 100 μm×100 μm square) of a TEM image of the sintered body, and checking that the maximum grain size is not greater than 200 nm, and the minimum grain size is not less than 20 nm.

When the length t2 of the sides in the a-axis direction is 200 nm that is the maximum value and the length t1 of the sides in the c-axis direction is 20 nm that is the minimum value, the aspect ratio t2/t1 is 10. Thus, 10 that is defined by such desirable crystal grain size range is the upper limit value of the aspect ratio t2/t1. It should be noted that the grounds for defining the lower limit value are described in the following paragraphs that illustrate the experimental results.

Meanwhile, the planar shape of each crystal grain g2 shown in FIG. 4b is an ellipse, and the major axis thereof is the long side in the a-axis direction, and the minor axis thereof is the shot side in the c-axis direction. In this specification, the ellipse has a “shape that is close to the rectangle.” As in FIG. 4a, each of t1 and t2 is in the range of 20 to 200 nm, and the aspect ratio t2/t1 is in the range of 1.4≦t2/t1≦10.

Further, the planar shape of each crystal grain g2 shown in FIG. 4c is a parallelogram, hexagon, elongated track shape, or the like, and each of such shapes is also a “shape that is close to the rectangle.” In addition, as in FIGS. 4a and 4b, each of t1 and t2 is in the range of 20 to 200 nm, and the aspect ratio t2/t1 is in the range of 1.4≦t2/t1≦10.

When the planar shape of each crystal grain g2 is a rectangle or a shape that is close to the rectangle as shown in FIGS. 4a, 4b, and 4c, the stereoscopic shape thereof is a polyhedron (i.e., a hexahedron (i.e., a cuboid), an octahedron, or a solid that is close thereto) whose surface of the crystal grain is surrounded by low-index (Miller index) planes. For example, when the stereoscopic shape is a hexahedron, the axis of orientation is formed on the (001) plane (i.e., the easy direction of magnetization (i.e., the c-axis direction) coincides with the top and bottom faces of the hexahedron), and the side faces are formed of (110), (100) or a Miller index that is close thereto.

### (Molded Body and Production Method Therefor)

FIG. 1c is a diagram illustrating a method for producing a molded body. The carbide punch P is made to abut the end faces of the produced sintered body S in the longitudinal direction thereof (in FIG. 1b, the horizontal direction is the longitudinal direction), and hot deformation processing (high-strength processing) is applied thereto while pressure is applied with the carbide punch P (in the X-direction), whereby a molded body C with a crystalline structure containing nanocrystalline grains with magnetic anisotropy is produced.

The hot deformation processing is preferably performed at about 600 to 800° C., which is a low temperature range in which plastic deformation can occur and coarsening of the crystal grains is difficult to occur, and further at a strain rate of about 0.01 to 30/s in a short time, with which coarsening can be suppressed, and desirably, under an inert gas atmosphere to prevent oxidation of the resulting molded body.

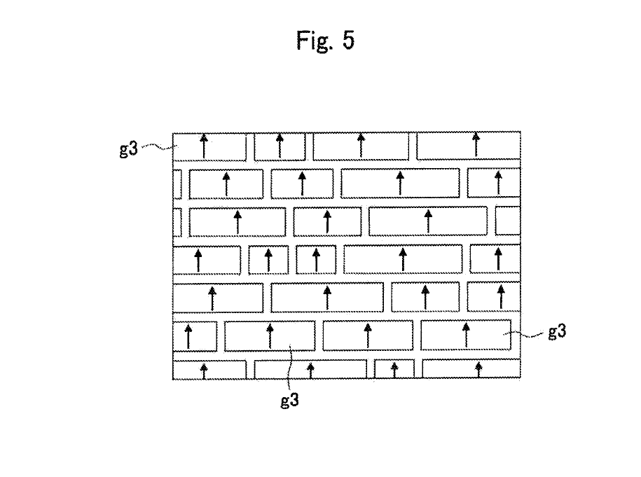

Next, the structure of the formed molded body C that is a precursor of a rare-earth magnet will be described with reference to FIG. 5. It should be noted that the molded body C shown herein is a molded body that is produced by applying hot deformation processing to a sintered body with crystal grains g2 whose planar shapes are rectangular as shown in FIG. 4a.

When the crystal grains g2 that form the sintered body have rectangular planar shapes (the structure may partially include shapes that are close to rectangles) having short sides (with a length of t1) in the easy direction of magnetization (i.e., the c-axis direction) and long sides (with a length of t2) in the a-axis direction that is perpendicular to the c-axis direction, have crystal grains in the grain size range of about 20 to 200 nm, and further have a crystal structure whose aspect ratio t2/t1 is in the range of 1.4≦t2/t1≦10, the isotropic crystal grains g2 will easily turn during high-strength processing as shown in FIG. 4a, and thus becomes an anisotropic molded body in which crystal grains g3 are aligned with a high degree of orientation as shown in FIG. 5.

A heavy rare-earth element such as Dy or Tb is added to a grain boundary phase that forms the molded body containing the crystal grains g3 with a degree of orientation that is greater than or equal to about 90% through diffusion permeation, either alone or in combination with an alloy of transition metal or the like, whereby a rare-earth magnet that is excellent in both magnetization and coercivity is produced.

“Experiments of determining relationship between aspect ratio of long side/short side of planar shape of each crystal grain of sintered body and degree of orientation of molded body that is obtained by applying hot deformation processing to sintered body, and results thereof”

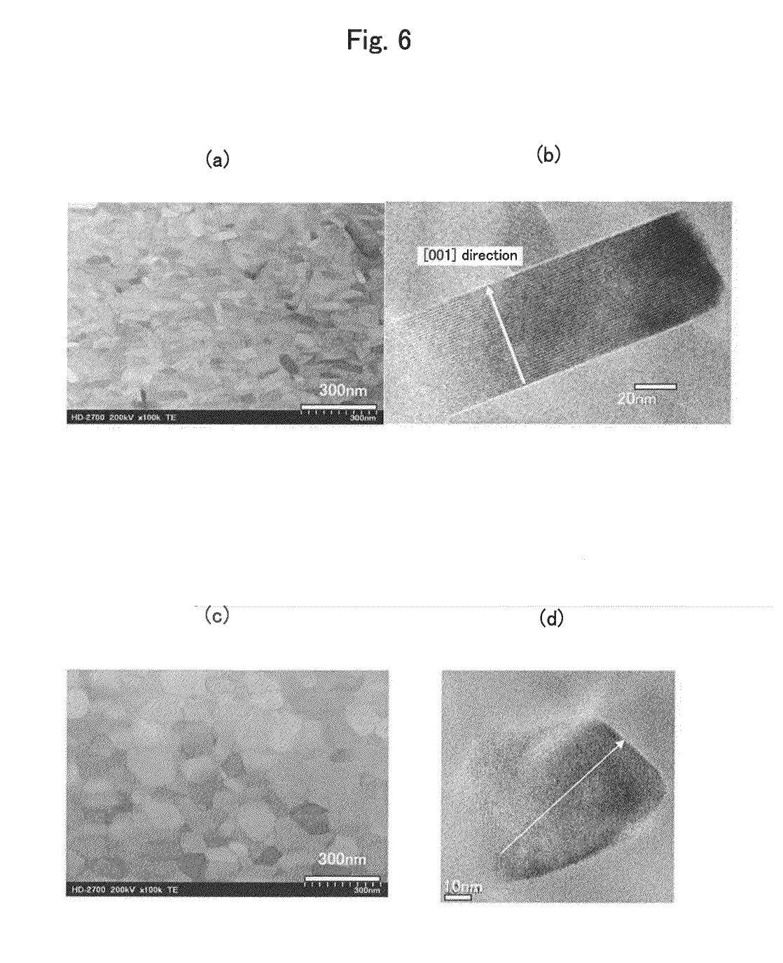

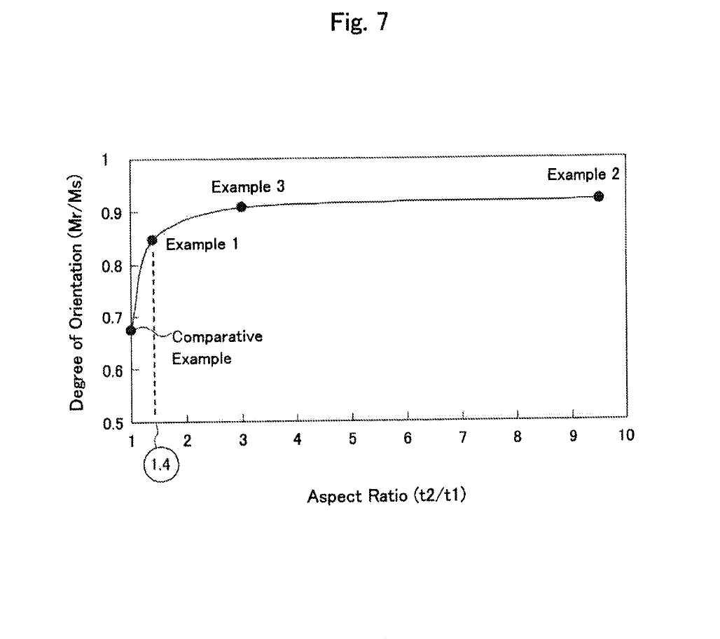

The inventors produced molded bodies of Examples 1 to 3 and a molded body of a comparative example using the following methods, and analyzed the crystal orientations from TEM images of sintered bodies that are precursors of the respective molded bodies, and then measured the aspect ratio t1/t2 (where the average value of the lengths of the short sides in the c-axis direction is t1, and the average value of the lengths of the long sides in the a-axis direction that is perpendicular to the c-axis direction is t2), and further measured the degrees of orientation of the respective molded bodies using a VSM (Vibrating Sample Magnetometer). Hereinafter, production methods of Examples 1 to 3 and the comparative example will be described, and the experimental results related to the aspect ratios of the respective sintered bodies and the degrees of orientation of the molded bodies are shown in Table 1 and FIG. 7. In addition, SEM image views and TEM image views of Examples 2 and 3 and the comparative example are shown in FIG. 6.

### Example 1

Quenched powder with a composition of Nd13.64Pr0.19Fe75.66Cu4.47B5.47Ga0.57 (mass %) containing no coarse grains was produced through single-sided cooling, and then the quenched powder was ground and separated into amorphous magnetic powder and crystalline magnetic powder through magnetic separation. Next, only the amorphous magnetic powder was collected and heat treatment was applied thereto at a temperature of 650° C. for 30 minutes, and then the magnetic powder was held at 620° C. for 5 minutes with a pressure of 400 MPa applied thereto, whereby a sintered body was produced. After the structure of the sintered body was observed with TEM, hot deformation processing was applied thereto at a temperature of 780° C. and at a strain rate of 8/s to produce the molded body of Example 1.

### Example 2

Quenched powder with a composition of Nd13.64Pr0.19Fe75.66Cu4.47B5.47Ga0.57 (mass %) containing no coarse grains was produced through single-sided cooling, and then the quenched powder was ground and separated into amorphous magnetic powder and crystalline magnetic powder through magnetic separation. Next, only the crystalline magnetic powder was collected and held at 620° C. for 5 minutes with a pressure of 400 MPa applied thereto, whereby a sintered body was produced. After the structure of the sintered body was observed with TEM, hot deformation processing was applied thereto at a temperature of 780° C. and at a strain rate of 8/s to produce the molded body of Example 2.

### Example 3

Quenched powder with a composition of Nd16Fe77.4B5.4Ga0.5Al0.5Cu0.2 (at %) containing no coarse grains was produced through single-sided cooling, and then the quenched powder was ground and separated into amorphous magnetic powder and crystalline magnetic powder through magnetic separation. Next, only the amorphous magnetic powder was collected and heat treatment was applied thereto at a temperature of 575° C. for 30 minutes, and then the magnetic powder was held at 570° C. for 5 minutes with a pressure of 300 MPa applied thereto, whereby a sintered body was produced. After the structure of the sintered body was observed with TEM, hot deformation processing was applied thereto at a temperature of 650° C. and at a strain rate of 0.02/s to produce the molded body of Example 3.

### Comparative Example

Quenched powder with a composition of Nd16Fe77.4B5.4Ga0.5Al0.5Cu0.2(at %) (mass %) containing no coarse grains was produced through single-sided cooling, and then the quenched powder was ground and separated into amorphous magnetic powder and crystalline magnetic powder through magnetic separation. Next, only the amorphous magnetic powder was collected and held at 570° C. for 5 minutes with a pressure of 300 MPa applied thereto, whereby a sintered body was produced. After the structure of the sintered body was observed with TEM, hot deformation processing was applied thereto at a temperature of 650° C. and at a strain rate of 0.1/s to produce the molded body of the comparative example.

FIG. 6a is a SEM image view of the sintered body that is a precursor of the molded body of Example 2, FIG. 6b is a TEM image view of the sintered body that is a precursor of the molded body of Example 3, FIG. 6c is a SEM image view of the sintered body that is a precursor of the molded body of the comparative example, and FIG. 6d is an enlarged TEM image view of FIG. 6c.

FIGS. 6a and 6b can confirm that the planar shape of each crystal grain of the sintered bodies of Examples 2 and 3 is a rectangle or a shape that is close to the rectangle, and the short sides of the crystal grain are 30 to 40 nm (i.e., not less than 20 nm) and the long sides thereof are about 150 nm or less (i.e., not greater than 200 nm).

Meanwhile, FIGS. 6c and 6d can confirm that the planar shape of each crystal grain of the sintered body of the comparative example is a shape that is close to a circle (i.e. equi-axed grain).

TABLE 1

| | Aspect Ratio of Crystal Grain of | Degree of |
|---|---|---|
| | Sintered Body (t2/t1) | Orientation (%) |
| Example 1 | 1.4 | 84.7 |
| Example 2 | 9.5 | 91.1 |
| Exmaple 3 | 3 | 90.8 |
| Comparative | 1.0 | 67.4 |
| Exmaple | | |

FIG. 7 shows the measured values of Examples 1 to 3 and the comparative example and an approximated curve that passes through the measured values.

Table 1 and FIG. 7 can confirm that an aspect ratio of 1.4 of Example 1 is an inflection point of the curve, and in the range in which the aspect ratio is lower than 1.4, the degree of orientation abruptly decreases (the degree of orientation of the comparative example is lower than that of Example 1 by about 20%, and is lower than those of Examples 2 and 3 by about 30%), and in the range in which the aspect ratio is higher than 1.4, the degree of orientation is saturated at about 90%.

Such experimental results define the preferable range of the lower limit value of the aspect ratio t2/t1 as 1.4≦t2/t1≦10.

Such experimental results can confirm that when each crystal grain that forms a sintered body has a planar shape that is a rectangle having short sides (with a length of t1) in the c-axis direction and long sides (with a length of t2) in the a-axis direction that is perpendicular to the c-axis direction, or a shape that is close to the rectangle, and is a crystal grain in the grain size range of 20 to 200 nm, and further has a crystal structure whose aspect ratio t2/t1 is in the range of 1.4≦t2/t1≦10, the crystal grain will easily turn during high-strength processing. Thus, a molded body with a high degree of orientation, and thus, a molded body that is a precursor of a rare-earth magnet with high remanent magnetization can be produced.

Although the embodiments of the present invention have been described in detail above with reference to the drawings, specific structures are not limited thereto. The present invention includes design changes and the like that may occur within the spirit and scope of the present invention.

### REFERENCE SIGNS LIST

R Chill roll
B Quenched ribbon (Quenched thin strip)
D Carbide die
P Carbide punch
S Sintered body
C Molded body
p Magnetic powder
g1 Crystal grains of quenched ribbon
g2 Crystal grains of sintered body
g3 Crystal grains of molded body
w Coarse grains

1. A sintered body that is a precursor of a rare-earth magnet, the sintered body including crystal grains of an Nd—Fe—B-based main phase with a nanocrystalline structure, and a grain boundary phase around the main phase, and the rare-earth magnet being adapted to be formed by applying hot deformation processing to the sintered body for imparting anisotropy thereto and further diffusing an alloy for improving coercivity therein,
wherein each of the crystal grains that form the sintered body has a planar shape that is, when viewed from a direction perpendicular to an easy direction of magnetization (i.e., a c-axis direction), a rectangle having sides in the c-axis direction and sides in a direction (i.e., an a-axis direction) that is perpendicular to the c-axis direction, or a shape that is close to the rectangle.

2. The sintered body that is a precursor of a rare-earth magnet according to claim 1, wherein provided that a length of the sides in the c-axis direction is t1 and a length of the sides in the a-axis direction is t2, the planar shape is in a range of 1.4≦t2/t1≦10.

3. The sintered body that is a precursor of a rare-earth magnet according to claim 2, wherein each of t1 and t2 is in a range of 20 to 200 nm.

4. A method for producing magnetic powder for forming the sintered body that is a precursor of a rare-earth magnet according to claim 1, comprising:
discharging a Nd—Fe—B-based metal melt onto a surface of a chill roll;
solidifying the metal melt through liquid quenching at a quenching speed in a range of 10⁵ to 10⁶ K/s to produce a quenched ribbon; and
grinding the quenched ribbon into the magnetic powder.

5. The method for producing magnetic powder for forming the sintered body that is a precursor of a rare-earth magnet according to claim 1, comprising:
discharging a Nd—Fe—B-based metal melt onto a surface of a chill roll;
solidifying the metal melt through liquid quenching at a quenching speed outside a range of 10⁵ to 10⁶ K/s, and applying heat treatment at 500 to 800° C. to produce a quenched ribbon; and
grinding the quenched ribbon into the magnetic powder.
